(19) United States
(12) Patent Application Publication
(10) Pub. No.: US 2005/0198203 A1
(43) Pub. Date: Sep. 8, 2005

(54) Method and system for controlling remote computers

(76) Inventors: Chin-Fu Tsai, Taipei (TW); Te-Hsien Lai, Panchiao City (TW); Kai-Feng Chiu, Taipei Hsien (TW); Tsai-Hung Huang, Taoyuan Hsien (TW)

Correspondence Address: RABIN & BERDO, P.C., Suite 500, 1101 14th Street, N.W., Washington, DC, 20005, US

(21) Appl. No.: 11/025,045

(22) Filed: Dec. 30, 2004

(30) Foreign Application Priority Data
Mar. 4, 2004 (TW) 93105759

(51) Int. Cl. G06F 15/16; G06F 15/173

(52) U.S. Cl. 709/218; 709/223

(57) ABSTRACT

A three-tier architecture is utilized for controlling a plurality of remote computers in both text mode and graphic mode. System Management Servers (SMS) are placed between browsers and the remote computers. Firstly, users select one remote computer via the browser. The browser communicates with the SMS, and then the SMS communicates with the selected remote computer via an out-of-band channel. Correspondingly, the selected remote computer redirects its text console data to the browser. IP address is also obtained via the three-tier architecture and then users utilize the browser to access a graphic server of the selected remote computer according to the IP address for controlling and monitoring the remote computer.

### RELATED APPLICATIONS

The present application is based on, and claims priority from, Taiwan Application Serial Number 93105759, filed on Mar. 4, 2004, the disclosure of which is hereby incorporated by reference herein in its entirety.

### FIELD OF THE INVENTION

The present invention relates to a method and a system for controlling remote computers, and more particularly, to the multi-tiered system and method for controlling remote computers.

### BACKGROUND OF THE INVENTION

Human being is more and more relied on computers and various electronic devices to deal with daily affairs. In all kinds of organizations such as corporations, etc., hundreds or even thousands of computers are commonly used and are often placed at different locations. When the computers do not work, IT personals often have to head to places where the broken computers are located, thus not only wasting a lot of time but also likely resulting in operation stoppage for the entire enterprise.

For example, one bank may have forty branches in one city, and each branch has one server for handling account-transfer tasks. When twenty of the computers are down due to virus attack, it may only take ten minutes for an IT personal to process each broken computer, but the account-transfer system of the entire city is completely shutdown for the whole morning due to traveling time for the IT personal to trip to the sites, thus not only result in a big income loss but also affecting the reputation of the bank.

Further, if the computers cannot be controlled remotely, IT personals' work loads will be greatly increased with more servers purchased in a company, which means that higher manpower cost will be needed.

Currently, the existing remote computer control includes using an intranet with software to operate remote computers. However, when a remote computer has severe problems, the software also cannot perform its function since the entire software system of the remote computer has been out of function. While meeting this situation, IT personals still have to travel to the remote computer site to restore the system or process other configuration setup.

The other problem resides in the system initialization in BIOS while the remote computer is being reset. At this stage, the aforementioned software cannot be used for operating remote computers since application programs such as an operating system, etc. are not loaded to the remote computes yet. Further, at this stage, the computer system merely provides a simple text mode for IP personals to process setup.

Currently, although there is a BMC (Baseboard Management Control) structure used for performing a reset operation of a remote computer, yet it frequently has to match with special client software. When the rest and reconfiguration is done, IP personals further need to activate another graphic-mode software for operating the remote computer.

However, the remote computer does not have an IP address while in initialization, and instead, uses a machine identification code (such a MAC address). Therefore, when IP personals need to control a remote computer in a graphic mode, they have to set up an IP address for the remote computer, thus not only causing a lot of troubles and lacking efficiency. Those described above are the problems of the current technologies of controlling remote computers.

Hence, if convenient remote control method and system can be designed for go beyond the text and graphic modes, then the information system management can have great contribution.

### SUMMARY OF THE INVENTION

Therefore, the object of the present invention is to provide a method and a system for controlling remote computers, thereby allowing users to simultaneously process the text-mode monitor and the graphic-mode monitor via networking. According to an embodiment of the present invention, a method for controlling remote computer is provided and comprises the following steps. At first, a system manager server (SMS) is used to obtain text console data, and the text console data is provided by a system management circuit of the remote computer via an out-of-band channel. The contents of the text console data include display data of the remote computer in initialization, reset or configuration.

Thereafter, the remote console data is displayed on a browser. The browser issues a command to the SMS, and the SMS obtains an IP address of the remote computer in accordance with the command via the system management circuit. Then, the browser accesses graphic console data of the remote computer via the IP address.

In implementation, when the text mode is switched to the graphic mode, the browser waits a predetermined period of time in accordance with an instruction code in such as Java Applet etc., and then the aforementioned graphic console data is redirected via the SMS.

Accordingly, a user can use one single interface to control a remote computer simultaneously with the text mode and the graphic mode under a flexible three-tiered structure, thereby greatly benefiting the computer management and lowering the cost thereof.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic structural diagram of a preferred embodiment of the present invention;

FIG. 2 a schematic view showing a three-tiered logic structure of the preferred embodiment of the present invention;

FIG. 3 a schematic view showing the structure of the remote computer according to the preferred embodiment of the present invention;

FIG. 4 is a schematic operational diagram of the preferred embodiment of the present invention;

FIG. 5 is a flow chart showing an example of text-mode operation;

FIG. 6 is a flow chart showing an example of graphic-mode operation;

FIG. 7(a) is an exemplary display shown on a browser;

FIG. 7(b) is another exemplary display shown on a browser;

FIG. 7(c) is another exemplary display shown on a browser; and

FIG. 7(d) is another exemplary display shown on a browser.

### DETAILED DESCRIPTION OF THE PREFERRED EMBODIMENT

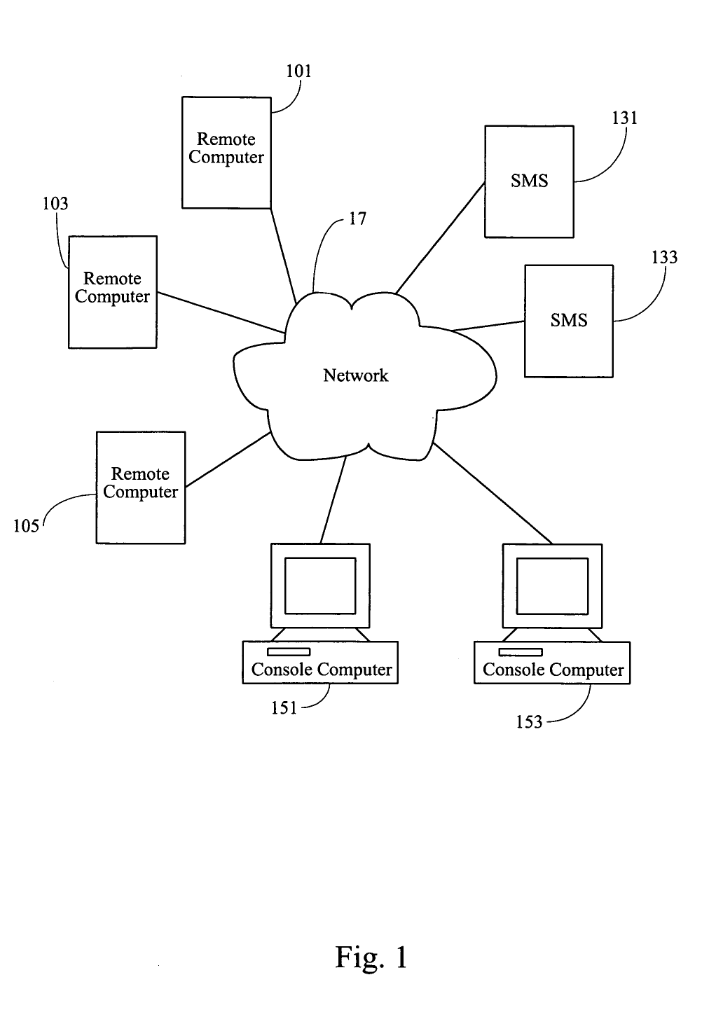

FIG. 1 is a schematic structural diagram of a preferred embodiment of the present invention. A plurality of remote computers 101, 103 and 105 are connected to a network 17, and further, a plurality of system management servers (SMSs) 131 and 133; and a plurality of console computers 151 and 153 are also connected to the network 17. A system administer uses the console computer 151 or 153 to control the remote computers 101, 103 and 105 through the SMS 131 or 133

In implementing the present invention, the network 17 can be a network of one identical area, and certainly can be the assembly of multiple networks. For example, the remote computer 101 and the SMS 131 can be connected via a local area network (LAN) or an Intranet, and then the console computer 151 is connected to the SMS 131 via the Intranet after passing through several nodes.

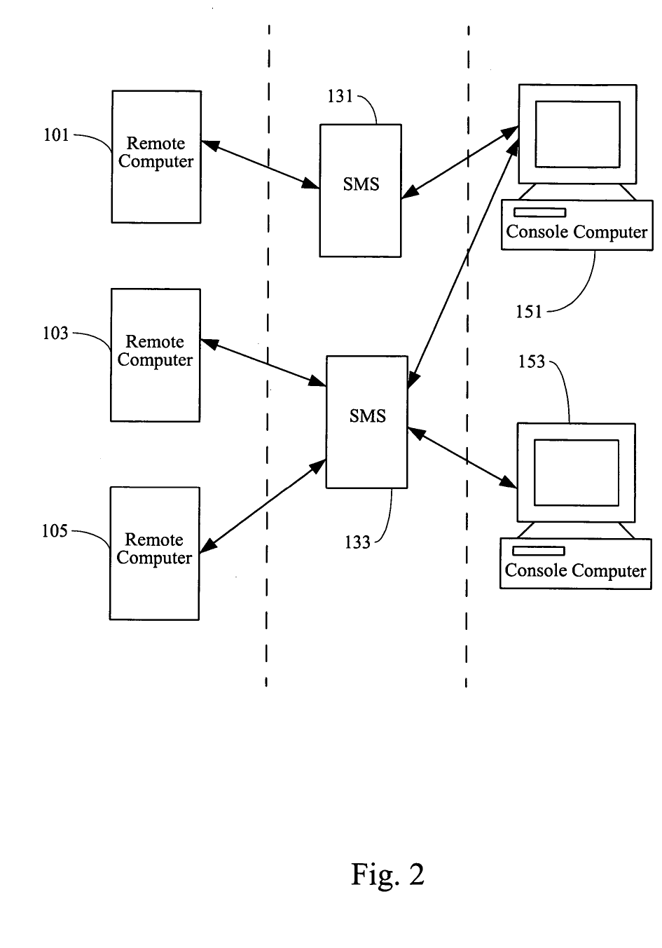

FIG. 2 is used to exemplarily showing FIG. 1 in accordance with the other point of view for particularly pointing out its three-tiered logic structure. By the three-tiered structure, the console computer can be connected to the remote computer indirectly, but uses the SMS as an intermediary agent, thereby enhancing the flexibility and scalability of use. For example, although different remote computers 101 and 103 are equipped with different SMSs 131 and 133, yet they still can be accessed by the same console computer 151 with the same interface such as a browser.

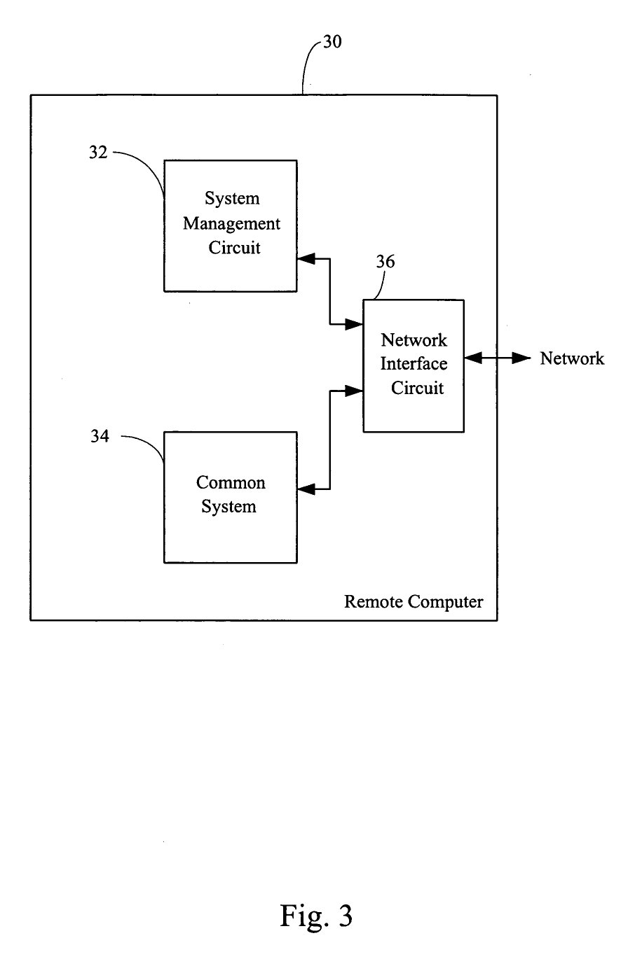

FIG. 3 is a diagram illustrating the structure of the remote computer 30 of this embodiment. The remote computer 30 can be such as a common personal computer, a workstation, a server or an industrial computer of various types, and is not limited to the computer having the I/O devices of monitor and mouse, etc. The remote computer 30 has a system management circuit 32, a common system 34 and a network interface circuit 36. In the present embodiment, the system management circuit 32 and the common system 34 use the network interface circuit 36 commonly to connect to the network. In an actual implementation, the system management circuit 32 is BMC chip, and the common system 34 is a computing system composed of a CPU, a memory and a hard disk driver. Further, in the actual implementation, the system management circuit 32 is a subsystem used for performing management and control job for the common system 34. Meanwhile, the system management circuit 32 is connected to the network via the network interface circuit 36, i.e. data and signals are transmitted through different substantial channels, i.e. an out-of-band channel called herein. In contrast, the common system 34 is connected to the network via the network interface circuit 36, which is called an in-band channel. The embodiments introduce below not only utilizes the out-of-band channel to provide a text-mode operation for the remote computer 30, but also utilizes the in-band channel to perform a graphic-mode operation for the remote computer 30.

As to the existing known computer system including the examples listed in the remote computer systems described above, initialization procedure or basic configuration is frequently performed via a BIOS while the computer system is in startup or reset. At the startup or reset stage, the system usually provides a user control interface in a text mode. After the initialization operation at startup is done, the computer system starts loading an operation system and executing application programs. The popularly used operation systems, such as Microsoft Windows or Linux, all provide graphic interfaces after execution for user convenience.

Hereinafter, the description will be stated with regard to how to provide an interface via the three-tiered structure shown in FIG. 2 for a user to apply a text-mode startup procedure, and also to automatically provide the user with console data continuously after the start-up procedure is done.

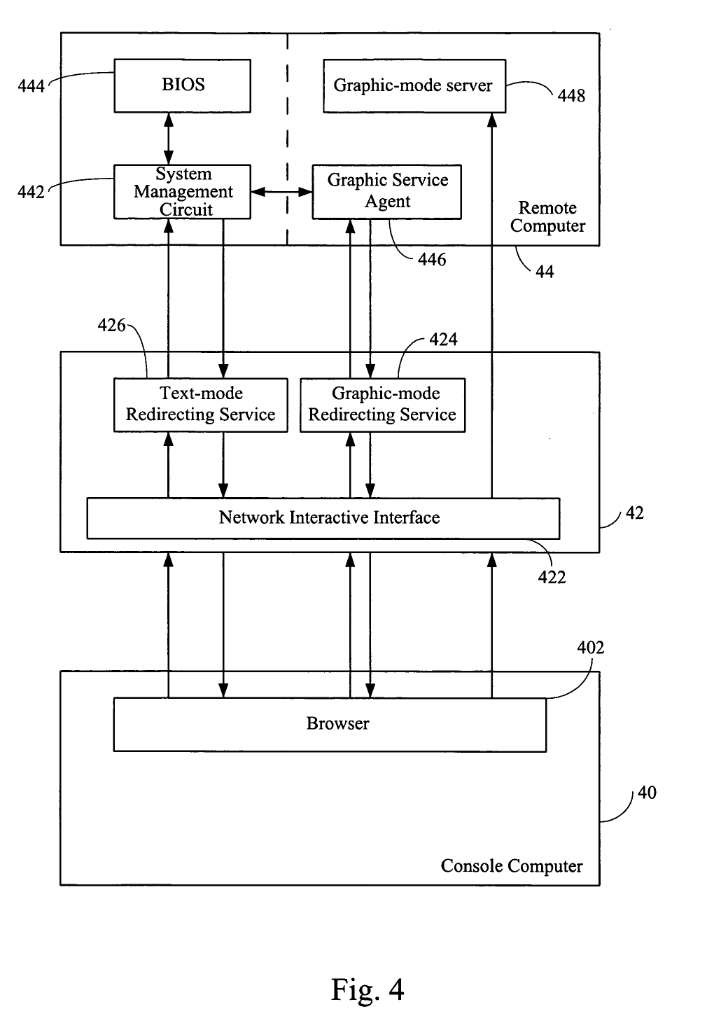

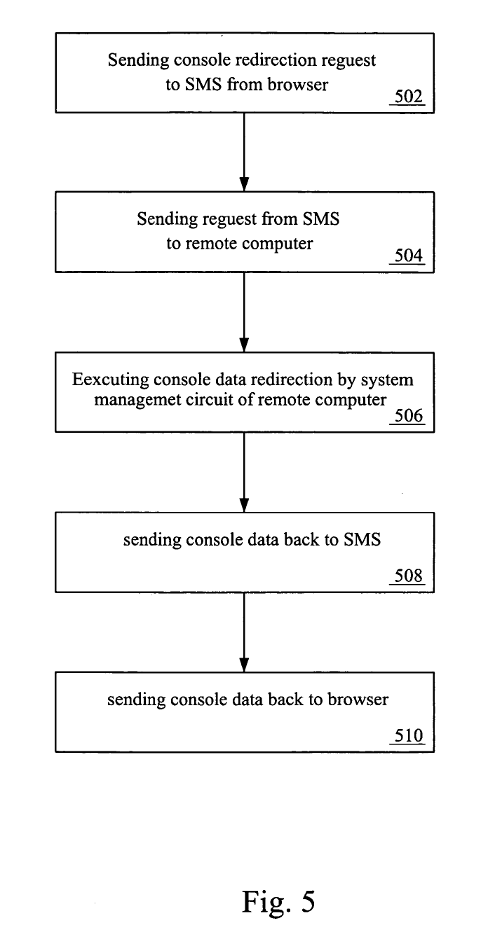

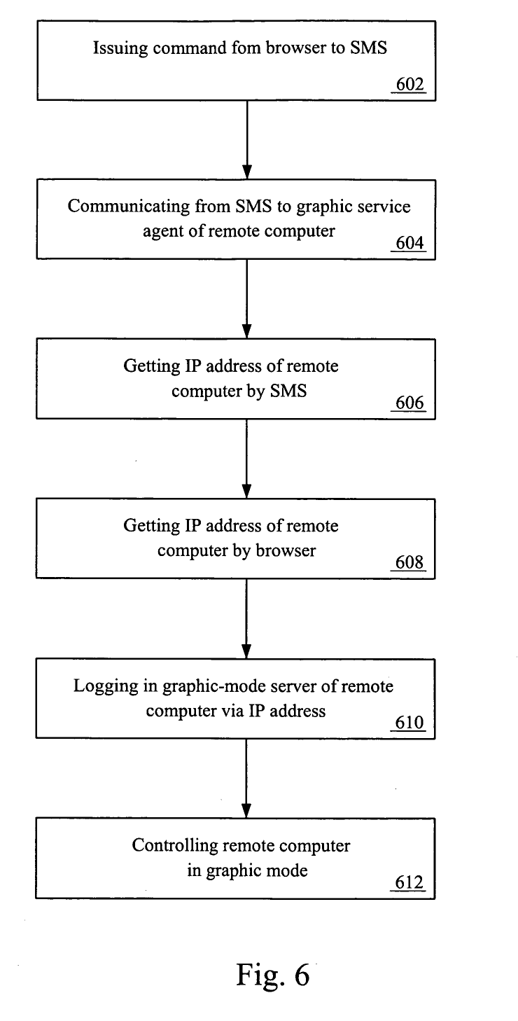

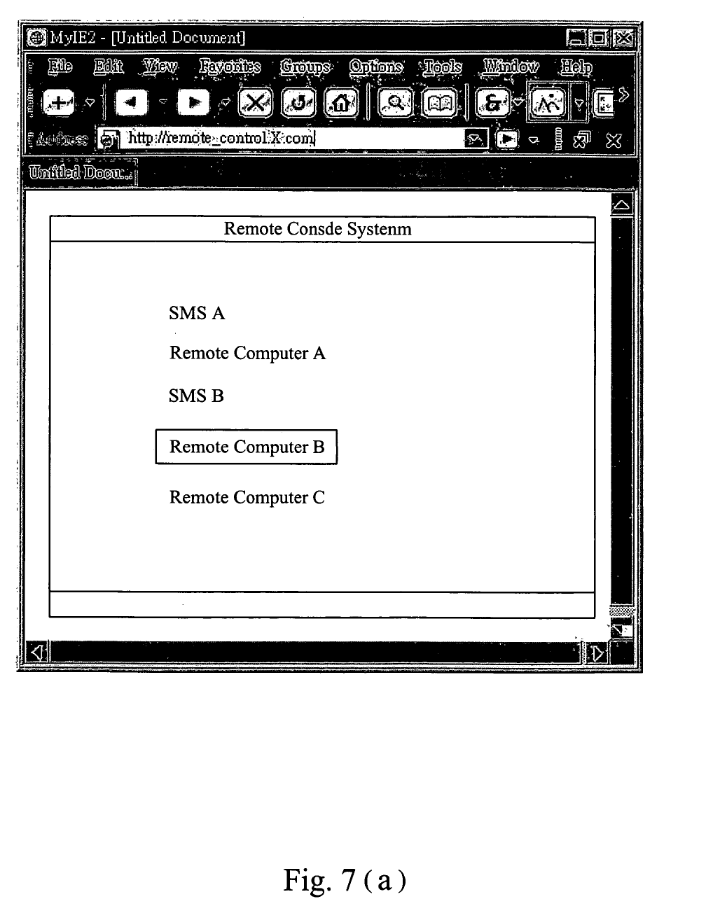

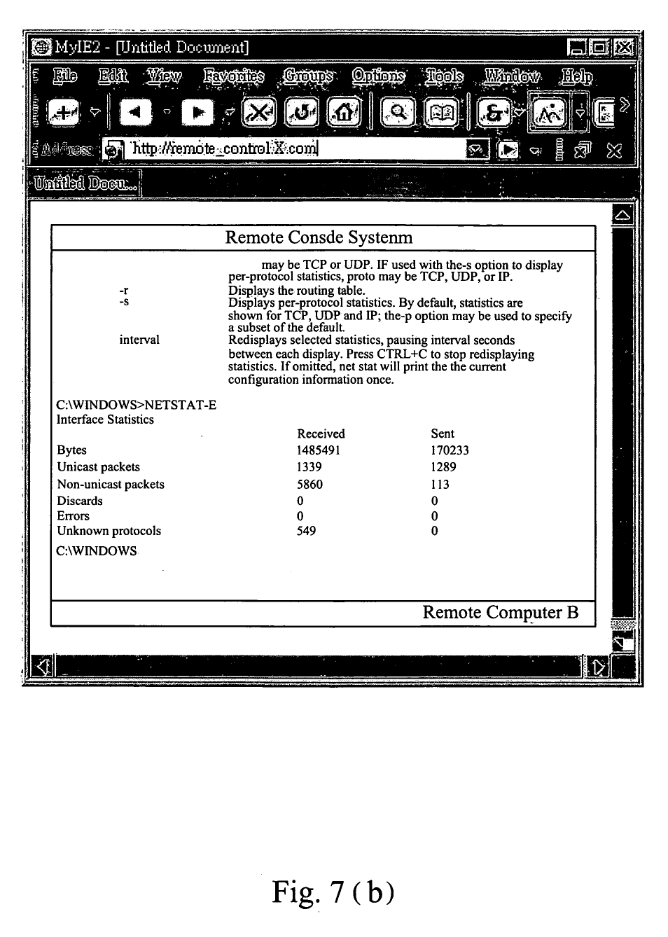

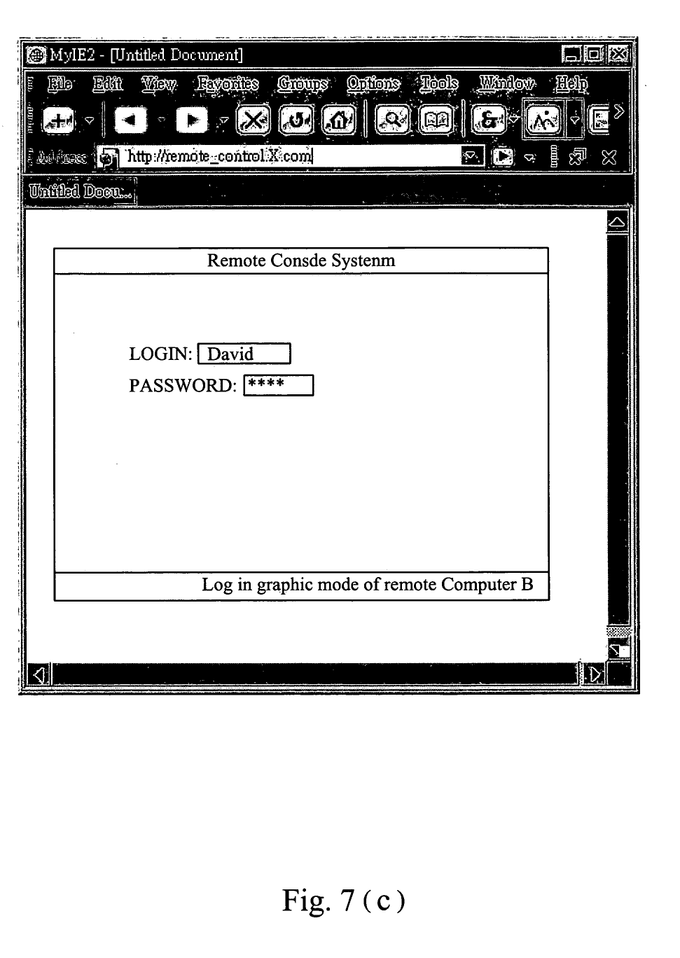

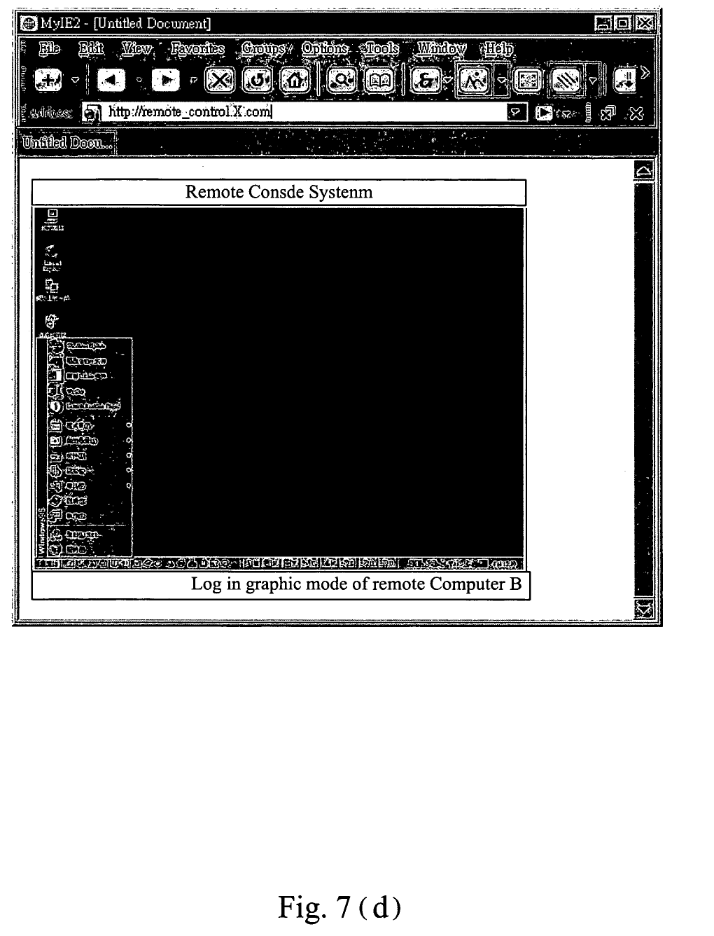

FIG. 4 is a schematic operational diagram of the preferred embodiment of the present invention. Additionally, FIG. 5 and FIG. 6 are used respectively to show how the method system and method provide the user with text-mode and graphic-mode console data. FIG. 7(a) to FIG. 7(d) are the exemplary displays showing the operation procedure.

In the example shown in FIG. 4, a SMS 42 has a web interactive interface 422, such as ASP (Active Server Page), JSP (JAVA Server Pages), PHP (Hypertext Preprocessor) or various CGI (Common Gate Interfaces) written in Perl, C Pascal or assembly language. Besides the web interactive interface 422, the SMS 42 also includes a text-mode redirecting service 426 and a graphic-mode redirecting service 424. It is noted that the web interactive interface 422, the text-mode redirecting service 426 and the graphic-mode redirecting service 424 do not have to be positioned on the same machine, and can be installed on multiple machines.

Further, in this example, the remote computer 44 has a system management circuit 442, a BIOS chip 444, a graphic-mode server 448 and a graphic service agent 446. The graphic service agent 446 and the graphic-mode server 448 belong to the aforementioned common system 34, i.e. the application programs executed in the operating system. As to the system management circuit 442, it is responsible for managing and controlling various hardware states and settings.

At first, how to transmit the text-mode console data to a user will be explained herein. The user connects to the web interactive interface 422 via a browser 402 so as to get an instruction code and enter a command. The browser 402 can be the browsers including a Microsoft Internet Explorer, a Netscape browser and any client program that can access data via a predetermined interface.

Referring to FIG. 5, FIG. 5 is a flow chart showing an example of text-mode operation. For example, the user uses the browser to connect to the web interactive interface 422 of the SMS 42 via Internet, and retrieves the display as shown in FIG. 7(a) on the browser. The user selects a remote computer, and then the browser 402 sends a console redirection request of the selected remote computer 44 to the SMS 42 (step 502).

The web interactive interface 422 transfers the request to the text-mode redirecting service 426. The example for practically enabling the text-mode redirecting service 426 is an object or a software module, and the text-mode redirecting service 426 sends the request to the remote system management circuit 422 (step 502). In implementation, the text-mode redirecting service 426 can use Telnet and a port 23 to transmit the related redirecting commands and parameters.

Thereafter, the system management circuit 422 issues a command to the BIOS chip 444 via an I/O port, thus redirecting the output of the BIOS chip 444 to the system management circuit 442 (step 506).

Then, the system management circuit 442 uses TCP/IP protocol to send the text-mode console data back to the text-mode redirecting service 426 via an out-of-band channel (step 508). Thereafter, the text-mode redirecting service 426 sends the text-mode console data received back to the browser 402 via the web interactive interface 422 (step 510), such as the display shown in FIG. 7(b) on the browser 402 of the console computer 40. The user can further use the text-mode console data to make the input for processing various settings, such as BIOS setting, etc., thereby controlling the remote computer 44.

The text-mode console data can be redirected through the aforementioned steps, thereby enabling the user to control the remote computer 44 via a three-tiered structure. Since the remote computer usually loads a graphic-mode operating system and allows the graphic-mode operating system to control the remote computer after the operation of the text-mode console data is done, it is not proper to perform the authority of controlling the entire remote computer 44 purely by redirecting the BIOS chip 444. At this point, the authority of controlling the entire remote computer 44 can be performed by switching to a remote operation of graphic-mode in a predetermined period of time, such as several seconds after the aforementioned remote operation of text-mode remote is done. The following description is stated for explaining how to further automatically redirecting the graphic-mode console data.

Referring to FIG. 6, FIG. 6 is a flow chart showing an example of graphic-mode operation. Just as described above, the browser 402 is operated in accordance the instructions codes written in such as Java Applet etc. In implementation, by writing the corresponding instruction codes, the browser 402 sends a command of redirecting graphic data to the web interactive interface 422 (step 602).

The web interactive interface 422 then transfers the command to the graphic-mode redirecting service 424 for processing (step 604). The graphic-mode redirecting service 424 is responsible for management and coordination and has communication with the graphic service agent 446 in terms of the related parameters and commands.

Thereafter, the graphic service agent 446 and the web interactive interface 422 process the communication therebetween via IPMI (Intelligent Platform Management Interface) commands, whereby the SMS 42 gets IP information of the graphic service agent 446 (step 606), and then transfers the IP information to the browser 402 (step 608). The IPMI is a protocol and command format established by the company such as INTEL for use in the communication between a BMC system management circuit and a motherboard or other parts of the system.

Then, the browser 402 uses the IP address to log in the graphic-mode server 448 of the remote computer (step 610). The graphic-mode server 448 is operated after the operating system of the remote computer 44 is loaded, thereby providing the service of redirecting the graphic console data. Further, for security control, the graphic-mode server can be designed with an accessing control scheme such as passwords, etc. When the user logs in the graphic-mode server 448 via the browser 402, the exemplary display is shown as in FIG. 7(c).

After the user logs in the graphic-mode server 448 smoothly, the operation of switching the text mode to graphic mode is done, and the remote computer 44 is controlled in the graphic mode (step 44), wherein the display is such as shown FIG. 7(d).

In other words, via the aforementioned method and system design, the user is allowed to use a three-tiered structure of flexibility and expandability to control and operate remote computers via network. Meanwhile, the aforementioned control and operation not only covers the text-mode operation regarding the startup procedure and settings, but also covers the subsequent graphic-mode operation by using one identical interface. Thus, the user can operate and control remote computers more efficiently, and certainly, much more remote computers can be monitored at the same time.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

1. A method for controlling remote computers, said method comprising:
obtaining a console data from a remote computer by using a system manager server (SMS), wherein said console data is provided by a system management circuit of said remote computer via an out-of-band channel;
displaying said console data on a browser;
issuing a command to said SMS by said browser;
obtaining an IP address of said remote computer by said SMS in accordance with said command via said system management circuit; and
accessing a graphic console data of said remote computer via said IP address by said browser, thereby allowing a user to control said remote computer.

2. The method of claim 1, wherein said system management circuit is a BMC (Baseboard Management Control) chip.

3. The method of claim 2, wherein said BMC chip is redirected to the BIOS settings of said remote computer for obtaining said text console data.

4. The method of claim 1, further comprising:
issuing said command by said browser after waiting a predetermined period of time.

5. The method of claim 1, wherein said console data include text console data and said graphic console data, and said text console data relates to the startup and configuring procedure for initializing said remote computer.

6. The method of claim 1, wherein said graphic console data are provided by an application program of said remote computer via said IP address.

7. The method of claim 5, wherein said SMS comprises a web interface, a text-mode redirecting service, and a graphic-mode redirecting service, wherein said web interface gets said text console data and said graphic console data respectively from said text-mode redirecting service and said graphic-mode redirecting service, and supplies said text console data and said graphic console data to said browser.

8. The method of claim 1, wherein said browser is operated by an instruction code

9. The method of claim 1, wherein the coding of said instruction code is a Java Applet program.

10. The method of claim 1, wherein said IP address is obtained from said system management circuit via an IPMI (Intelligent Platform Management Interface) format.

11. A system fore controlling remote computers, said system comprising:
a browser provided for showing a text console data and a graphic console data;
a system management server (SMS) coupled to said browser via a network, wherein said SMS supplies said text console data and said graphic console data to said browser; and
a remote computer having a system management circuit coupled to said SMS, wherein said system management circuit redirects the data used for controlling said remote computer as said text console data to said SMS via an out-of-band channel, and supplies an IP address to said browser via said SMS, thereby letting said browser use said IP address to access said graphic control of said remote computer.

12. The system of claim 11, wherein said system management circuit is a BMC chip.

13. The system of claim 12, wherein said BMC chip is redirected to the BIOS settings of said remote computer for obtaining said text console data.

14. The system of claim 11, wherein said browser issues said command to said SMS after waiting a predetermined period of time.

15. The system of claim 1, wherein said text console data relates to the startup and configuring procedure for initializing said remote computer.

16. The system of claim 11, wherein said graphic console data are provided by an application program of said remote computer via said IP address.

17. The system of claim 11, wherein said SMS comprises a web interface, a text-mode redirecting service, and a graphic-mode redirecting service, wherein said web interface gets said text console data and said graphic console data respectively from said text-mode redirecting service and said graphic-mode redirecting service, and supplies said text console data and said graphic console data to said browser.

18. The system of claim 11, wherein said browser is operated by an instruction code.

19. The system of claim 11, wherein the coding of said instruction code is a Java Applet program.

20. The system of claim 11, wherein said IP address is obtained from said system management circuit via an IPMI format.
